(19) United States
(12) Patent Application Publication
(10) Pub. No.: US 2011/0313665 A1
(43) Pub. Date: Dec. 22, 2011

(54) Method for Automatically Detecting a Driving Maneuver of a Motor Vehicle and a Driver Assistance System Comprising Said Method

(75) Inventors: Stefan Lueke, Olpe (DE); Ken Schmitt, Heppenheim (DE); Rolf Isermann, Seeheim-Jugenheim (DE); Stefan Habenicht, Rossdorf (DE); Andree Hohm, Obernburg (DE); Roman Mannale, Darmstadt (DE); Christian Wojek, Leutershausen (DE); Hermann Winner, Bietigheim (DE); Bernt Schiele, Saarbruecken (DE)

(73) Assignees: ADC AUTOMOTIVE DISTANCE CONTROL SYSTEMS GMBH, Lindau (DE); CONTINENTAL TEVES AG & CO. OHG, Frankfurt (DE)

(21) Appl. No.: 13/201,020

(22) PCT Filed: Mar. 4, 2010
(86) PCT No.: PCT/DE10/00233

§ 371 Date: Aug. 11, 2011

(30) Foreign Application Priority Data
Mar. 4, 2009 (DE) 10 2009 011 222.7
Jul. 28, 2009 (EP) 09 009 730.4
Aug. 4, 2009 (DE) 10 2009 035 987.7

(51) Int. Cl. B60W 30/08

(52) U.S. Cl. 701/301

(57) ABSTRACT

The invention relates to a method for automatically detecting a driving maneuver of a motor vehicle (A), in particular an overtaking maneuver or an evasive maneuver, in which
the surroundings of the vehicle are covered and an electronic image thereof is created,
the electronic image is used for the detection of a traffic lane and/or of a road as well as of-objects (B, C) in the surroundings of the vehicle,
longitudinal-dynamics and lateral-dynamics movement information (\dot{ψ}, α_{y}, δ_{H}, ω_{FL}, ω_{FR}, ω_{RL}, ω_{RR}) of motor vehicle (A) is determined, and
the position (\hat{X}) of motor vehicle (A) is odometrically estimated on the basis of the data (b_{Lane}, y_{Lane}, θ, c₀) of lane detection and/or road detection and/or of the movement information (\dot{ψ}, α_{y}, δ_{H}, ω_{FL}, ω_{FR}, ω_{RL}, ω_{RR}) of motor vehicle (A),
   wherein the invention provides that
   a) the following indicator quantities are formed from the estimated position data (\hat{X}) of motor vehicle (A):
a value of the lateral distance (LO_{L}, LO_{R}) of motor vehicle (A) from a road marking or traffic line (L),
a time-to-collision value (TTC_{A,B}) relative to the distance (d) from the object (B) located in the direction of motion, in particular from the vehicle driving ahead (B),
a longitudinal-dynamics overtaking-or-evasive-maneuver indicator (I) formed from the indicator quantity (TTC_{A,B}) of the time-to-collision value and from a value that corresponds to the position (FPS) of the gas pedal of motor vehicle (A), and
   b) that threshold values (Iₜₕ, TTC_{A,B,th}) are determined for said indicator quantities (LO_{L}, LO_{R}, TTC_{A,B}, I), which threshold values are used as criteria for detecting partial maneuvers of an overtaking or evasive maneuver, in particular a maneuver to follow a vehicle driving ahead, a lane change, a maneuver to pass the stationary or moving object (B) and a maneuver to cut into the lane of the overtaken object (B), as well as for detecting transitions between said partial maneuvers.

The invention relates to a method for automatically detecting a driving maneuver of a motor vehicle, in particular an overtaking maneuver or an evasive maneuver, according to the preamble of patent claim 1. The invention further relates to a driver assistance system comprising said inventive method according to patent claim 13.

A method for avoiding collisions between a vehicle and oncoming vehicles is known from DE 10 2004 018 681 A1. According to said method, driving recommendations, in particular for an intended overtaking maneuver, are generated from the instantaneous velocity and from the current distances of the vehicle from a vehicle driving ahead in the same direction. Any oncoming vehicles are detected by at least one radar device and taken into consideration when generating said driving recommendations.

For effectively supporting a driver with driving recommendations, it is necessary to reliably identify the driver's intention. In particular, it is necessary to be able to reliably predict an overtaking maneuver and the partial maneuvers thereof as well as the beginning of an overtaking maneuver already before the actual occurrence thereof.

For example, a method for identifying the driver's intention is described in Blaschke, C.; Schmitt, J.; Färber, B.: “Überholmanöver-Prädiktion Über CAN-Bus-Daten”, Automobiltechnische Zeitschrift, vol. 110, no. 11/2008, pp. 1024-1028. According to said method, one tries to identify the three driver's intentions “turning off”, “following the road” and “overtaking” on the basis of the input data “brake pressure”, “gas pedal position”, “driving velocity” and “distance from an intersection” and the ACC information by means of a fuzzy logic approach. However, a disadvantage of this method consists in the fact that no lateral-dynamics movement quantities of the vehicle are used for identifying the driver's intention and that a difficult parameterization is necessary, wherein it is difficult to interpret the used quantities by means of the complex fuzzy logic system.

Furthermore, another method for identifying the driver's intention is known from Kretschmer, M; König, L.; Neubeck, J.; Wiedmann, J.: “Erkennung and Prädiktion des Fahrerverhaltens während eines Überholvorgangs”, 2. Tagung Aktive Sicherheit durch Fahrerassistenz, Garching, 2006. According to said method, vehicle and surroundings quantities, such as the steering-wheel angle, steering angular velocity, vehicle velocity, longitudinal acceleration, road steering angles (curvature) determined from GPS data and digital maps, the distance from and the relative velocity with respect to the vehicle driving ahead as well as the lateral offset of the vehicle, are used for detecting an overtaking maneuver. However, a disadvantage of this known method consists in the fact that it is necessary to use high-precision GPS receivers and digital maps.

In addition, the point in time of the beginning of an overtaking maneuver and thus of the entry into the oncoming lane cannot be predicted by means of any of the two methods described last.

Therefore, the object of the invention is to provide a method for detecting a driving maneuver, in particular an overtaking maneuver or an evasive maneuver of the above-mentioned type, by means of which the aforementioned disadvantages are avoided and which in particular can be carried out in a simple manner and with few parameters and by means of which it is nevertheless possible to reliably detect and predict overtaking maneuvers. Furthermore, the object of the invention is to provide a driver assistance system comprising the inventive method, said system making a good assessment of the danger potential of a detected or predicted overtaking maneuver possible.

The first-mentioned object is achieved by a method with the features of patent claim 1.

Said inventive method is characterized in that

a) the following indicator quantities are formed from the estimated position data of the motor vehicle:
a value of the lateral distance of the motor vehicle from a road marking or traffic line,
a time-to-collision value relative to the distance from the object located in the direction of motion, in particular from the vehicle driving ahead,
a longitudinal-dynamics overtaking-or-evasive-maneuver indicator formed from the indicator quantity of the time-to-collision value and from a value that corresponds to the position of the gas pedal of the motor vehicle, and
   b) that threshold values are determined for said indicator quantities, which threshold values are used as criteria for detecting partial maneuvers of an overtaking or evasive maneuver, in particular a maneuver to follow a vehicle driving ahead, a lane change, a maneuver to pass the stationary or moving object and a maneuver to cut into the lane of the overtaken object, as well as for detecting transitions between said partial maneuvers.

The advantage of this inventive method consists in the fact that the estimated quantities from odometry as well as the surroundings data with respect to a vehicle that is to be overtaken or with respect to an object (e.g., an obstacle) the collision with which is to be avoided are condensed into longitudinal-dynamics and lateral-dynamics indicator quantities, whereby it becomes easy to interpret them, in particular with respect to the driven maneuvers and to the prediction of overtaking maneuvers.

The inventive method requires longitudinal-dynamics and lateral-dynamics movement information that is supplied to odometry, wherein at least one longitudinal-dynamics movement quantity, e.g., vehicle velocity and/or vehicle acceleration, can be determined from a rotational speed of a vehicle wheel. A piece of lateral-dynamics movement information can be determined by means of a yaw rate sensor and/or a lateral-acceleration sensor. It is also possible to exclusively derive and determine a piece of lateral-dynamics movement information from the difference between the rotational speeds of the left and the right vehicle wheels.

As against the state of the art, a smaller number of such indicator quantities are used for detecting driving maneuvers, wherein the advantage of these inventive indicator quantities consists in the fact that they require little parameterization effort and can be easily interpreted.

The driving maneuvers to be detected can be detected by means of a state diagram in which the driving maneuvers are modeled as states and the transitions between these maneuver states are modeled in dependence on said inventive indicator quantities.

According to a further development of the invention, a temporal measure of distance from the stationary or moving object located in the direction of motion, in particular from the vehicle driving ahead, and an associated threshold value serve to determine the state “following a vehicle driving ahead” or to determine the state “independent travel”.

According to an advantageous further development of the invention, a further indicator quantity is determined as a time-to-line-crossing value from the data of lane detection and/or road detection and from the movement information of the motor vehicle, and an associated threshold value is determined as a criterion, wherein said threshold value is used together with the criterion for the longitudinal-dynamics overtaking indicator for the prediction of the beginning of an overtaking maneuver or an evasive maneuver. In this way, the beginning of an overtaking maneuver is detected early, and thus it is also possible, within a driver assistance system, to perform an early analysis of the situation with respect to potential danger in order to be able to warn the driver in time if necessary. The forming of the threshold value as a criterion of the indicator quantity of the time-to-line-crossing value in dependence on the longitudinal-dynamics overtaking indicator is preferable, wherein the indicator quantity of the time-to-line-crossing value indicates the period of time that will pass before the vehicle crosses, e.g., the lane line that demarcates the oncoming lane. The indicator quantity of the time-to-line-crossing value is determined by means of lateral-dynamics movement information of the vehicle, e.g., by means of the yaw rate and/or the lateral acceleration of the vehicle since the curvature of the vehicle path is determined therefrom in a first step. It is also possible to estimate the curvature of the vehicle path on the basis of the difference between the rotational speeds of the vehicle wheels or from the steering-wheel angle.

The driving-maneuver state “following a moving object”, in particular “following a vehicle driving ahead”, is modeled with the indicator quantity of the temporal measure of distance, wherein the state “following” is detected when this indicator quantity falls short of the associated threshold value. Otherwise, the vehicle is assumed to be in the state “independent travel”.

Furthermore, according to an advantageous further development of the invention, a lane change or a maneuver to cut out into an adjacent lane is detected to be a partial maneuver of an overtaking maneuver and therefore interpreted as the beginning of an overtaking maneuver when the value of the indicator quantity of the lateral distance of the vehicle from a lane line that demarcates an oncoming lane is negative.

According to a further advantageous realization of the invention, an abortion of such a partial maneuver is detected when the indicator quantity of the time-to-collision value cannot be determined on the basis of the data of the movement information of the motor vehicle and of the value of the distance of the motor vehicle from the stationary or moving object located in the direction of motion, e.g., when the vehicle is slowed down so that the vehicle driving ahead cannot be reached any more, and/or when the indicator quantity of the lateral distance of the vehicle from a lane line that demarcates an oncoming lane becomes positive, i.e., the vehicle cuts back behind the vehicle driving ahead.

The partial-maneuver state “passing” is modeled by a negative value of the distance of the motor vehicle from the stationary or moving object located in the direction of motion, i.e., a continuation of an initiated overtaking maneuver is detected when the value is negative.

From this partial-maneuver state “passing”, a transition to a phase of aborting an overtaking maneuver is modeled by the indicator quantity of the time-to-collision value regaining its determinability, i.e., when the driver initiates a braking process while passing a vehicle driving ahead. An abortion of the passing maneuver is detected when this indicator quantity falls short of an associated threshold value.

According to an advantageous further development of the invention, a cutting-in maneuver as a partial maneuver completing an overtaking maneuver is detected when the value of the indicator quantity of the value of the lateral distance of the vehicle from a lane line that demarcates an oncoming lane becomes positive and when the indicator quantity of the value of the distance of the motor vehicle from the overtaken object, in particular from the vehicle driving ahead, is smaller than the negative sum of the length of the motor vehicle and of the overtaken object, e.g., of the vehicle driving ahead.

Advantageously, the value of the distance from the front right corner of the motor vehicle is used as an indicator quantity of the value of the lateral distance of the vehicle from a lane line demarcating an oncoming lane for detecting a cutting-in maneuver, whereas the value of the distance from the front left corner of the motor vehicle is used as an indicator quantity of the lateral distance from a lane line for detecting a lane change or a maneuver to cut out into an adjacent lane.

The second-mentioned object of the invention is achieved with the features of patent claim 13.

According to this, the inventive driver assistance system for a motor vehicle, in particular an overtaking-maneuver assistance system or an evasive-maneuver assistance system, comprises:
a surroundings sensor system for lane and road detection and for locating objects in the surroundings of the motor vehicle,
a sensor evaluation unit for creating an electronic image of the surroundings of the motor vehicle,
a vehicle sensor system for acquiring dynamic movement information,
a driving-maneuver detection device for carrying out the inventive method for detecting partial maneuvers of an overtaking or evasive maneuver, in particular a maneuver to follow a vehicle driving ahead, a lane change, a maneuver to pass a moving or stationary object and a maneuver to cut into the lane of an overtaken object, as well as for detecting transitions between said partial maneuvers,
an object-tracking device for tracking detected oncoming vehicles or objects on the basis of the surroundings sensor system, and
an evaluation device for assessing and determining the feasibility of the detected driving maneuvers and/or partial maneuvers with respect to the detected oncoming vehicles and/or objects, for controlling a warning device for outputting warnings to the driver when an overtaking maneuver has been predicted or during a detected overtaking maneuver when the detected driving maneuver and/or partial maneuver is assessed to be critical or non-feasible, and/or for actuating one or several modulators of vehicle-relevant functions, in particular the brake and/or the steering gear and/or the drivetrain, when the danger of a collision with a detected oncoming vehicle and/or object has been detected.

The use of such a driver assistance system using the inventive method includes the following actions: When an overtaking-maneuver situation or evasive-maneuver situation is detected, the possibility of safely performing or completing an overtaking maneuver started from the state “following a vehicle driving ahead” is continuously assessed. If necessary, the driver is warned, and the possibility of preventing a collision with an oncoming object by slowing down and cutting in behind the vehicle driving ahead is assessed, too. If such prevention is possible, the assistance system automatically slows the vehicle down at the latest possible moment so that the driver can cut back behind the vehicle driving ahead, wherein the intensity of the braking intervention can be preferably made dependent on the position the gas pedal is in at the time of intervention.

According to an advantageous realization of the inventive assistance system it is particularly advantageous to design the device for situation analysis for determining an indicator quantity for assessing a predicted or detected overtaking maneuver, wherein said indicator quantity is determined on the basis of the data of the vehicle sensor system and of the object-tracking device for the predicted time of the end of the predicted or detected overtaking maneuver as a time-to-collision value for the detected oncoming vehicle and/or object. On this basis, an overtaking maneuver can be predicted in such a manner that the relative kinematics of the involved vehicles is calculated for the whole period until the end of the overtaking maneuver. Therefore, said indicator quantity of the time-to-collision value for the detected oncoming vehicle and/or object can be already estimated prior to the beginning of the overtaking maneuver, wherein the associated threshold value is determined such that a sufficiently safe distance from the oncoming vehicle will remain after the completion of the overtaking maneuver. When said distance is too short, the driver is signaled that the oncoming vehicle is too close already and that the overtaking maneuver should be refrained from or aborted.

The driver can be warned acoustically, e.g., by means of speech, or visually or haptically.

In the following, the invention will be explained in greater detail with reference to the drawings in which

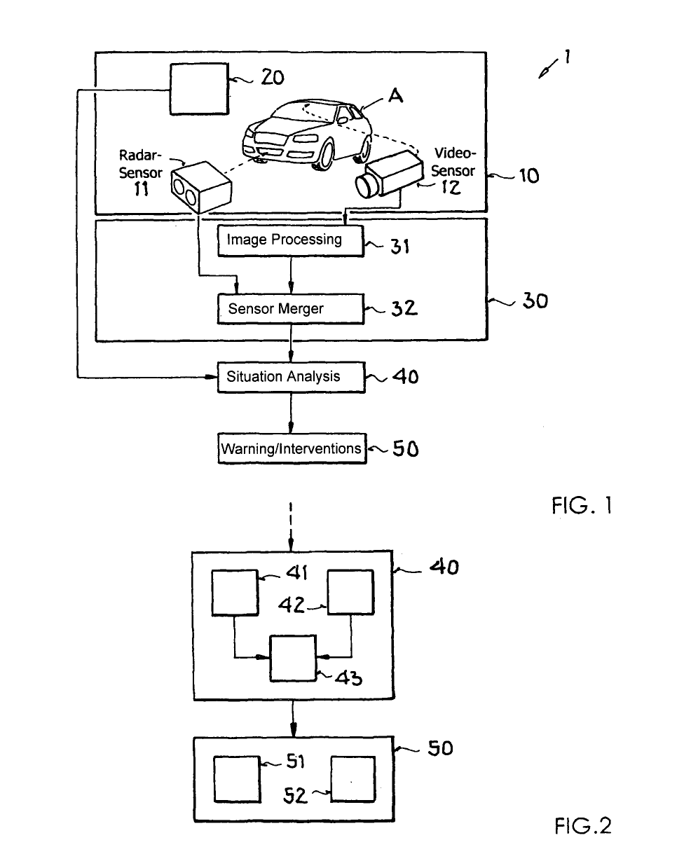

FIG. 1 shows a schematic representation of an exemplary embodiment of an inventive driver assistance system;

FIG. 2 shows a block diagram of a subsystem of the driver assistance system according to FIG. 1;

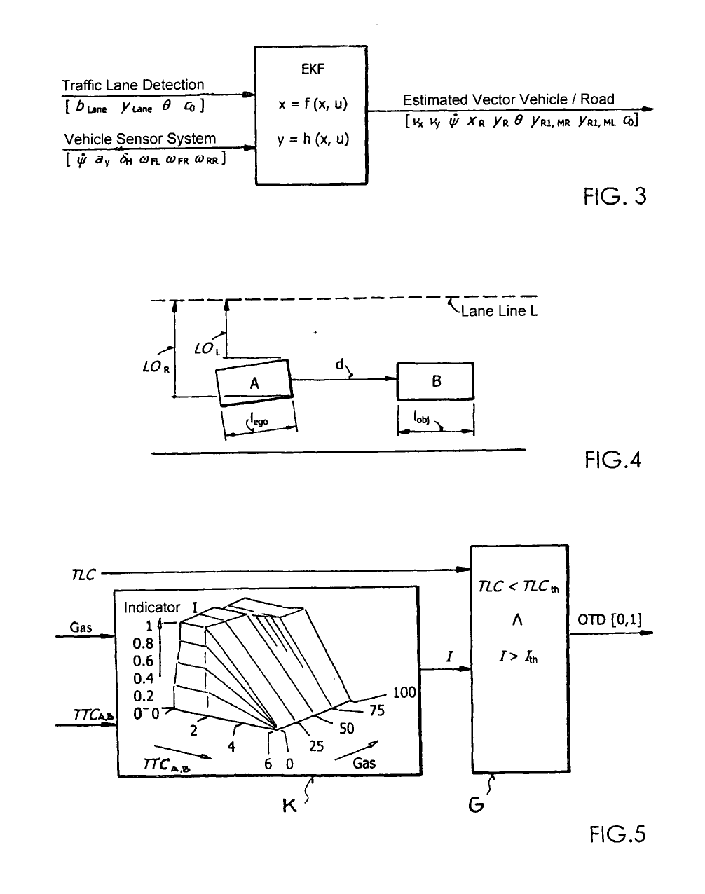

FIG. 3 shows a block diagram for illustrating the odometric determination of the vehicle position;

FIG. 4 shows a schematic representation of a vehicle state on a road for explaining the indicator quantities LO_{R} and LO_{L};

FIG. 5 shows a block diagram for explaining the detection of an overtaking maneuver;

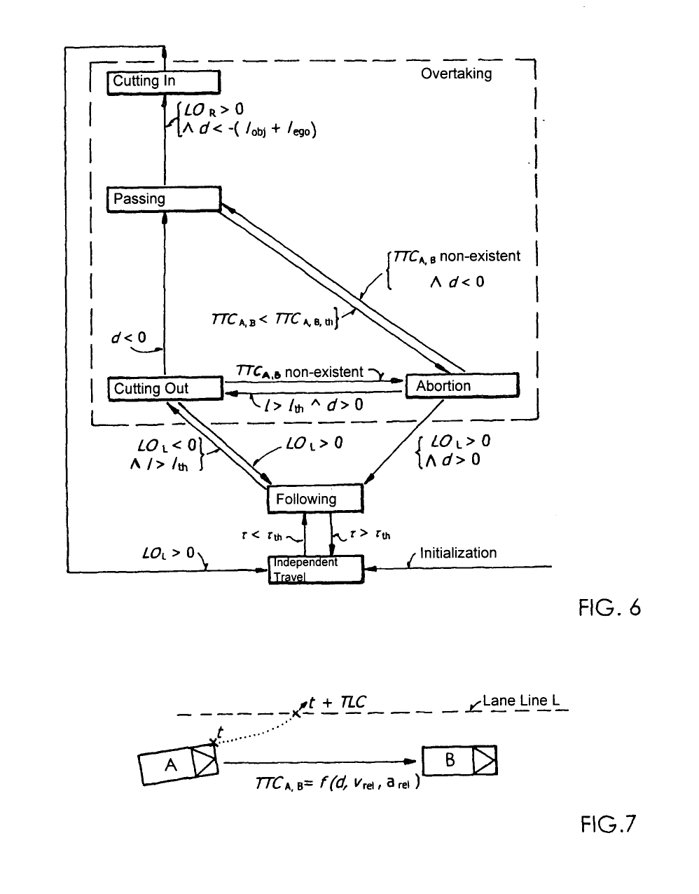

FIG. 6 shows a state diagram for determining partial maneuvers of an overtaking maneuver;

FIG. 7 shows a schematic representation of a vehicle state on a road for determining an indicator quantity TLC;

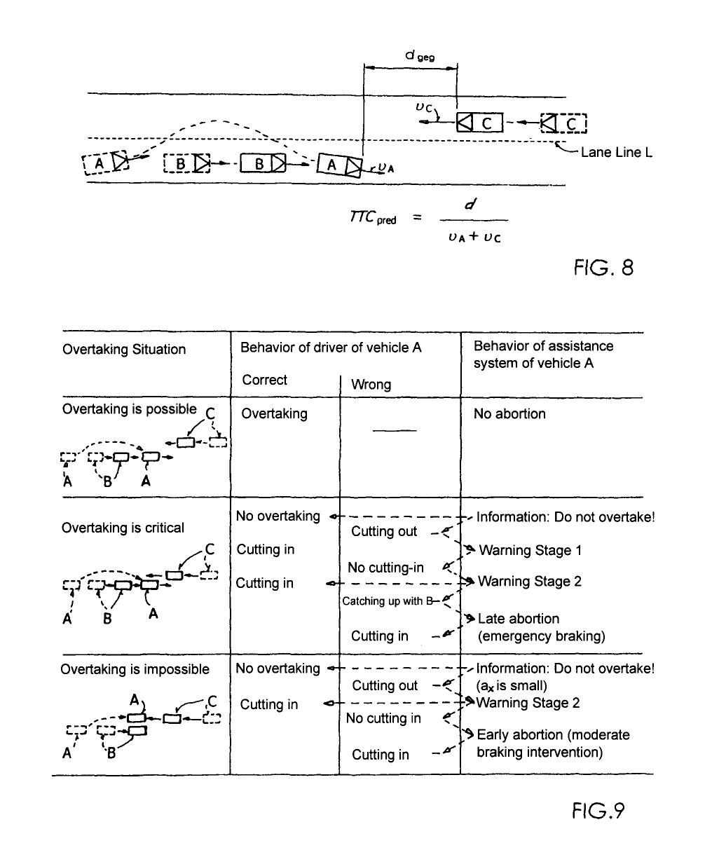

FIG. 8 shows a schematic representation of a traffic situation in the event of an overtaking maneuver with oncoming traffic;

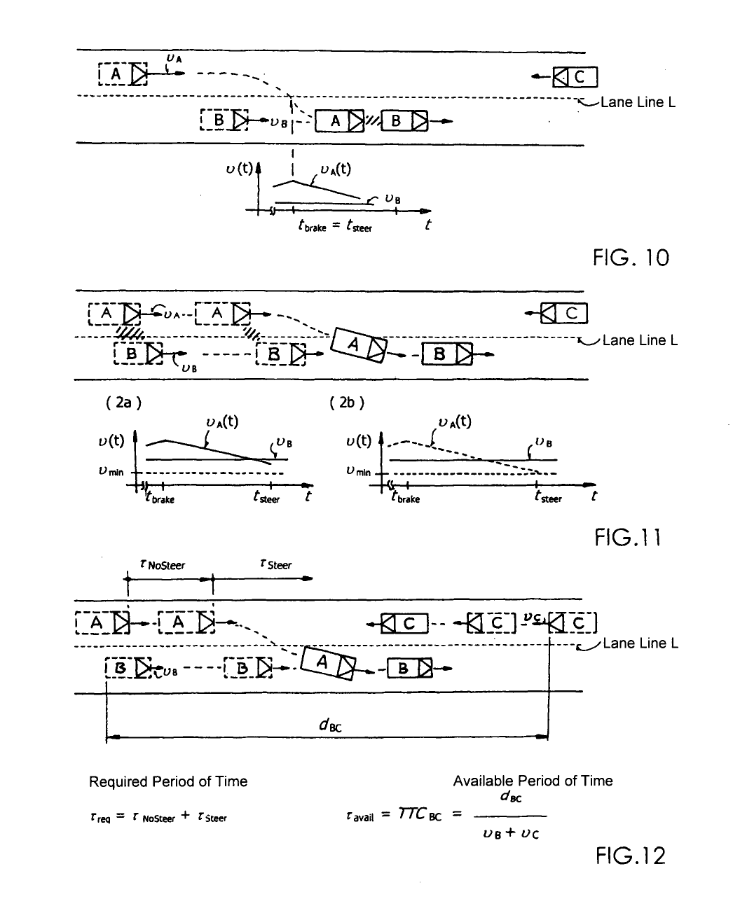

FIG. 9 shows a table with examples for overtaking situations;

FIG. 10 shows a schematic representation of a traffic situation of an aborted overtaking maneuver;

FIG. 11 shows a schematic representation of a further traffic situation of an aborted overtaking maneuver;

FIG. 12 shows a schematic representation of a traffic situation with oncoming traffic for determining the durations that are relevant to an abortion maneuver; and

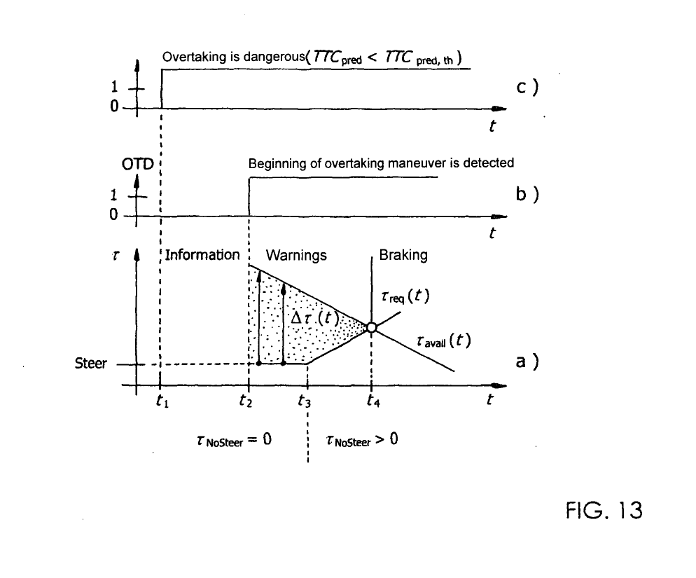

FIG. 13 shows time-dependency diagrams for illustrating the temporal interrelationships with respect to warnings and braking interventions of the inventive driver assistance system.

The schematic representation of a driver assistance system 1 according to FIG. 1 shows a motor vehicle A with a surroundings sensor system 10 for covering the surroundings of the vehicle and an associated vehicle sensor system 20 for acquiring vehicle-movement-dynamics quantities and other required quantities, e.g., the position of the gas pedal. The surroundings sensor system 10 is equipped with a radar sensor system 11 and a video sensor system 12 the data of which are acquired and evaluated in a sensor evaluation unit 30 for creating an electronic image of the surroundings of the vehicle. For this purpose, an image processing unit 31 performs an object detection and a detection of open spaces on the basis of the video data of the video sensor system 12 in a first step and a sensor merger unit 32 merges this information with the radar data of the radar sensor system 11 in a subsequent step so that the electronic image of the surroundings of the vehicle can be created therefrom.

The methods that have to be performed for creating such an electronic image are known to a person skilled in the art so that a basic explanation thereof will suffice and we will therefore refrain in the following from a detailed description thereof.

For example, a pixel-by-pixel segmentation of the video image into classes such as “road”, “vehicle”, “verge” or “bushes/forest” in the close range (up to about 50 m) is known to allow an image-based understanding of the scene and thus the calculation of obstacles and action spaces for evasive and braking maneuvers in emergency situations. Image segmentation is described in detail in “A dynamic conditional random field model for joint labeling of object and scene classes”, European Conference on Computer Vision (ECCV), Marseille, 2008, p. 733-747. Thus, a segmentation of the overall scene in the video image as well as object detections from an image-based object detector are available for subsequent processing in the sensor merger unit 32. The described image segmentation is optional since any other known image evaluation method is just as suitable. Such image segmentation is particularly suitable in connection with the determination of evasive maneuvers.

The radar sensor system 11 serves to detect oncoming objects.

The data of the radar sensor system 11 are merged with the image-based object detector from the image processing unit 31 in the sensor merger unit 32 in order to realize object tracking. If the yawing movement of motor vehicle A is taken into consideration, continuous object tracking without losing the track of the object is possible since the expected lateral offset of motor vehicle A is taken into consideration.

A situation analysis of the electronic image of the surroundings of the vehicle is performed in a situation analysis module 40, wherein also the data of the vehicle sensor system 20 are processed for this purpose. When the result of said situation analysis is the detection of a current driving maneuver being an overtaking maneuver or the detection of a corresponding intention of the driver, the danger of a collision with a detected oncoming vehicle is assessed by calculating the overtaking maneuver in advance.

In dependence on said assessment, a warning-and-intervention module 50 is triggered for outputting a warning to the driver and/or for triggering a modulator, e.g., for actuating the brakes of motor vehicle A.

In the following, the functions of said situation analysis module 40 and of the warning-and-intervention module 50 of the driver assistance system 1 will be described and explained in detail in connection with FIGS. 2 ff.

In order to enable the assistance system 1 to work towards an abortion of the overtaking maneuver by means of warnings or active interventions in a dangerous situation, situation analysis has to include the detection of the execution of the current driving maneuver on the one hand and the detection of the presence of a dangerous situation on the other hand.

Since driving maneuvers are essentially defined by the movement of the vehicle along and laterally to traffic lanes, the position of, the orientation of and the movement of the vehicle relative thereto are determined in a first step. For this purpose, the data of the vehicle sensor system 20 and of a traffic lane detection based on the data of the video sensor system are odometrically merged according to FIG. 3.

Odometry allows to estimate the position of, the velocity of and the orientation of the vehicle on the road as well as further state quantities. These estimated quantities are available for maneuver detection, for other situation analysis algorithms as well as for control tasks.

An extended Kalman filter (EKF) is used for state estimation.

For this purpose, the dynamics of the vehicle relative to the road as well as the observations by the used vehicle sensor system 20 and surroundings sensor system 10 are modeled in a state representation in the form of

\dot{x}=f(x,u) (process model),

y=h(x,u) (observation model)

and the data of the vehicle sensor system 20 and of a camera-based traffic lane detection are merged on the basis of the data of the video sensor system 12 by coupling a vehicle model and a road model according to FIG. 3.

The camera-based traffic lane detection delivers estimates of the relative yaw angle θ, of the curvature c₀ of the road, of the lane width b_{Lane} as well as of the lateral offset y_{Lane} of the vehicle relative to the middle of the lane (eccentricity).

The vehicle sensor system 20 delivers the required lateral-dynamics and longitudinal-dynamics movement information of vehicle A, according to FIG. 3 the quantities yaw rate \dot{ψ}, lateral acceleration α_{y}, wheel angle of lock δ_{H} and the four rotational speeds ω_{FL}, ω_{FR}, ω_{RL}, ω_{RR} of the vehicle wheels, wherein these quantities result in an optimal estimation of the estimated vector of the vehicle or of the road. For the function of the inventive method it is sufficient to determine a piece of longitudinal-dynamics movement information, e.g., longitudinal velocity, from at least one rotational speed of a wheel as well as a piece of lateral-dynamics movement information, e.g., as a yaw rate and/or lateral acceleration. A piece of lateral-dynamics movement information can be determined from the differences between the rotational speeds of the left and the right vehicle wheels by estimation as well as by detecting the steering-wheel angle of a steering wheel of the vehicle.

The observation model for lane width b_{Lane} and eccentricity used in the extended Kalman filter (EKF) is dynamically adapted when the reference lane of lane detection changes. The correct model equations are selected by comparing the measured quantities y from lane detection with the values h(x*,u) expected according to the prediction step of the extended Kalman filter (EKF). If lane detection momentarily breaks down, the corresponding observation model equations are omitted and estimation is temporarily continued exclusively on the basis of the vehicle sensor system, whereby inter-lane self-locating is achieved and momentary breakdowns of lane detection can be bridged odometrically. According to FIG. 3, the output of the extended Kalman filter (EKF) and thus of odometry is an estimate \hat{X} of the state vector

x=(vₓv_{y}\dot{ψ}x_{R} y_{R} θy_{R,M}_{_{R}} y_{R,M}_{_{L}} c₀),

wherein
vₓ and v_{y} represent the centroidal velocities in the longitudinal and lateral directions of the vehicle,
x_{R} and y_{R} represent the position of the vehicle in a road coordinate system,
θ represents the relative yaw angle,
y_{R,M}_{_{R}} und y_{R,M}_{_{L}} represent the lateral positions of the central and left traffic line with respect to the road coordinate system, and
c₀ represents the curvature of the road.

Lateral-dynamics and longitudinal-dynamics indicator quantities are formed on the basis of the estimated quantities of odometry as well as of surroundings data with respect to a vehicle that is to be overtaken. The actual detection of the various maneuvers is carried out by means of a state diagram in which the transitions between the various maneuvers are modeled in dependence on the indicator quantities.

The lateral position y_{R} on the road and the relative yaw angle θ are used as central lateral-dynamics quantities. Independently of the course of the road, these estimated quantities are expressive and allow the detection of lane change maneuvers. According to FIG. 4, the lateral distances of the front of the vehicle from the lane line LO_{L} and LO_{R} are formed as indicator quantities, wherein LO_{L} indicates the distance of the front left corner of vehicle A from the lane line and LO_{R} indicates the distance of the front right corner from the lane line.

Longitudinal-dynamics is additionally taken into consideration in order to determine whether the vehicle is just moving to the left in order to, e.g., turn off or whether the vehicle is really cutting out because the driver wants to overtake. There is a potential overtaking situation only when there is another vehicle B in front of ego-vehicle A. The time gap τ to the vehicle driving ahead B, as a measure of distance that can be interpreted independently of velocity, is used as a further indicator quantity:

$$τ = \frac{d}{v} ,$$

wherein d is the distance from the vehicle driving ahead B and v is the vehicle velocity of vehicle A.

A small distance d as well as a high relative velocity as well as a high relative acceleration relative to the vehicle driving ahead indicate the beginning of an overtaking maneuver. On the other hand, a great distance d, a low or even a negative relative velocity and relative acceleration indicate a lower probability of an overtaking maneuver since it would take a long time to overtake or since maintaining the state of motion would not result in catching up with the vehicle driving ahead.

Therefore, the predicted duration of an overtaking maneuver performed out of the current situation is used as a further longitudinal-dynamics indicator. However, since it is difficult to estimate the length l_{obj} of the vehicle driving ahead B in an early phase of an overtaking maneuver, the calculation of the time-to-collision quantity (TTC_{A,B}) is used, instead of the predicted duration of the overtaking maneuver, for maneuver detection (see FIG. 7), wherein the relative acceleration aᵣₑᵢ between vehicles A and B is taken into consideration:

$${TTC}_{A , B} = \frac{2 d}{{v}_{rel} \pm \sqrt{{v}_{rel} + 2 {da}_{rel}}} .$$

With this indicator quantity TTC_{A,B}, the quantities “distance d”, “relative velocity vᵣₑᵢ” and “relative acceleration aᵣₑᵢ” are represented in a single indicator, and the interpretation of the indicator is still possible in spite of neglecting the constant path elements (lengths l_{ego} and l_{obj} of vehicles A and B). Calculation is performed generally and regardlessly whether the vehicles are on a collision course.

However, even indicator quantity TTC_{A,B}, if viewed in isolation, is still not expressive as to whether a particular driving situation is an intended approach to a vehicle driving ahead B that indicates the beginning of an overtaking maneuver. On the one hand, a vehicle may approach a vehicle driving ahead B, but said approach is not intended but results from the vehicle driving ahead B slowing down. On the other hand, an approach to the vehicle driving ahead B may be intended, but the intensity of the response of vehicle A, and consequently of indicator quantity TTC_{A,B}, to the driver's intention is low because accelerating power is too low. However, the two cases mentioned above are detected by considering the position of the gas pedal: In the first case, indicator quantity TTC_{A,B} is small, but the driver is not accelerating. In the second case, indicator quantity TTC_{A,B} indicates only a medium approach to the vehicle driving ahead B but the gas pedal is largely floored. By means of such rules, indicator quantity TTC_{A,B} and the value of gas pedal position (FPS) can be integrated, by means of fuzzy logic, into a new indicator quantity I that eliminates the drawbacks of an indicator quantity TTC_{A,B} that is viewed in isolation. FIG. 5 shows a schematic representation of characteristic diagram K formed by means of fuzzy logic and smoothed in a subsequent step.

The indicator quantities that are derived from the estimated quantities of odometry as well as from the surroundings data with respect to a vehicle B that is to be overtaken and that are condensed and can be interpreted more easily are used for the detection of the driven maneuvers, i.e., overtaking maneuvers and partial maneuvers such as cutting out, passing and cutting in, and for the prediction of overtaking maneuvers.

In summary, the following indicator quantities are used:

LO_{R}: lateral distance of the lane line L of the traffic lanes from the front right corner of vehicle A
LO_{L}: lateral distance of the lane line L of the traffic lanes from the front left corner of vehicle A
d: distance from the vehicle driving ahead B
TTC_{A,B}: time-to-collision value
I: longitudinal-dynamics overtaking indicator
τ: time gap to the vehicle driving ahead B

The actual detection of the various maneuvers is carried out by means of a state diagram according to FIG. 6 in which the maneuvers are modeled as states and the transitions between the maneuver states are modeled in dependence on the indicator quantities. After initialization with the state “independent travel”, the state “following a vehicle driving ahead” is assumed if a time-gap threshold value τᵣᵢ with respect to a vehicle driving ahead B is fallen short of. The beginning of an overtaking maneuver is detected when the process proceeds to the state “cutting out”, i.e., when the value of the left distance LO_{L} indicates a crossing of lane line L and when the exceeding of a threshold value iₜₕ of the overtaking indicator I indicates an intention of overtaking. The process proceeds to the partial maneuver “passing” with the front of vehicle A leaving the rear of the vehicle to be overtaken B (vehicle driving ahead) behind (i.e., d<0) in the event of a continuation of the overtaking maneuver. After that, the partial maneuver “cutting in” is detected when vehicle A has completely passed the overtaken vehicle driving ahead B (i.e., d<−(l_{obj}+l_{ego}) according to FIG. 4), wherein l_{ego} and l_{obj} are the lengths of vehicle A and the vehicle driving ahead B, respectively, and when the process proceeds to cutting back into the ego-lane (i.e., LO_{R}>0). The end of the overtaking maneuver is detected when the cutting-in maneuver is completed (LO_{L}<0), whereupon vehicle A returns to the state “independent travel” and the driver selects, if necessary, a new reference vehicle.

An abortion of the overtaking maneuver during the cutting-out maneuver or the passing maneuver is detected on the basis of indicator quantity TTC_{A,B}. Indicator quantity TTC_{A,B} indicates how long it takes the front of vehicle A (when maintaining the state of motion) to reach a position where it is in one line with the rear of the vehicle driving ahead B that is to be overtaken. A deceleration of vehicle A during the partial maneuver “cutting out” and the impossibility of determining an indicator quantity TTC_{A,B} indicate that the vehicle driving ahead B will not be caught up with, i.e., that relative velocity vᵣₑᵢ is too low, which means that the maneuver has been aborted. When vehicle A is in the state “passing” and thus has already caught up with the rear of the vehicle to be overtaken B (vehicle driving ahead), indicator quantity TTC_{A,B} has to be interpreted differently: When the overtaking maneuver is continued, indicator quantity TTC_{A,B} cannot be determined any more since the front of vehicle A is not in one line with the rear of the overtaken vehicle B any more. However, the possibility of determining indicator quantity TTC_{A,B} during the passing maneuver indicates a deceleration of vehicle A. According to FIG. 6, an abortion is detected in this case when indicator quantity TTC_{A,B} can be determined and falls short of a limiting value TTC_{A,B,th}. In case the overtaking maneuver is continued after a short phase of hesitation, state transitions are additionally provided in order to detect, on the basis of the partial maneuver “aborting”, a continuation of the overtaking maneuver.

The beginning of an overtaking maneuver is to be predicted already prior to crossing lane line L of the traffic lane of vehicle A so that accident prevention measures can be early initiated in a dangerous situation. For this purpose, the time-to-line-crossing value (TLC) is formed as a further indicator quantity (see FIG. 7). TLC indicates, on the basis of the current dynamics of the movement of vehicle A, the period of time that will pass before the vehicle crosses lane line L.

According to FIG. 5, an AND gate G combines said indicator quantity TLC and the longitudinal-dynamics overtaking indicator I in a logic operation so that the beginning of an overtaking maneuver is predicted when the indicator quantity

TLC falls short of a threshold value TLCₜₕ and when the longitudinal-dynamics overtaking indicator I exceeds threshold value Iₜₕ, i.e., the output of gate G for signal OTD is 1.

Threshold value TLCₜₕ is dynamically adapted to the driving situation in order to achieve sufficient robustness in normal driving situations as well as to achieve early detection in the event of a real beginning of an overtaking maneuver. The more clearly the longitudinal-dynamics overtaking indicator I indicates an overtaking maneuver (according to characteristic K in FIG. 5), the more reliable the assumption that an observed approach to lane line L results from a beginning cutting-out maneuver. Therefore, the more the overtaking indicator exceeds threshold value Iₜₕ, the more threshold value TLCₜₕ is lowered starting from a particular value. Threshold value TLCₜₕ is adapted linearly, wherein threshold value TLCₜₕ reaches its minimum when the longitudinal-dynamics overtaking indicator I reaches its maximum.

When an overtaking situation is detected, the possibility of safely performing or completing an overtaking maneuver started from the state “following a vehicle driving ahead” or an overtaking maneuver that has already begun is continuously assessed. For this purpose, a model of acceleration behavior is used as a basis for predicting the overtaking maneuver and for calculating the relative kinematics of the involved vehicles A and B (see FIG. 8) for the whole period until the end of the overtaking maneuver. In case an overtaking maneuver has already been started, the real acceleration behavior of vehicle A is taken into consideration.

For the point in time of completely leaving the left traffic lane at the end of the overtaking maneuver, the time-to-collision quantity TTC_{pred} with respect to the oncoming traffic (here represented by vehicle C) is estimated according to the formula

$${TTC}_{pred} = \frac{{d}_{geg}}{{v}_{A} + {v}_{C}}$$

according to FIG. 8, wherein d_{geg} is the distance from the oncoming vehicle C, v_{A} is the velocity of the overtaking vehicle A and v_{C} is the velocity of the oncoming vehicle C.

Said quantity TTC_{pred} reflects the reserve for the distance from the oncoming traffic at the end of the overtaking maneuver and can be easily interpreted as a measure of time.

By means of the predicted TTC_{pred} it is possible to estimate already prior to or during the beginning of the overtaking maneuver whether a sufficiently safe distance d from the oncoming traffic will remain after the completion of the overtaking maneuver. When it falls short of a threshold value TTC_{pred,th}, the oncoming traffic is too close already and the overtaking maneuver should be refrained from or aborted.

In the driver assistance system 1 according to FIGS. 1 and 2, driving-maneuver detection is carried out in a driving-maneuver detection device 41 of the situation analysis module 40, and object tracking, e.g., of vehicle C, is carried out by means of an object-tracking device 42 of the situation analysis module 40. An evaluation device 43 of the situation analysis module 40 interprets the situation.

As soon as the evaluation device 43 indicates a dangerous overtaking maneuver, the driver assistance system 1 informs the driver by means of a warning device 51 triggered by the evaluation device 43, wherein the warning can be realized visually, acoustically and/or haptically. At the same time, the driver assistance system begins to plan an accident-prevention abortion maneuver. An early or a late abortion maneuver is necessary according to the distance and the relative velocity of the oncoming vehicle C at the beginning of the overtaking maneuver.

Concerning the above, the table according to FIG. 9 shows three examples for overtaking situations: an overtaking situation without an abortion, an overtaking situation with an early abortion, and an overtaking situation with a late abortion.

In the first case, an overtaking maneuver is possible when the value of indicator quantity TTC_{pred} is greater than the associated threshold value TTC_{pred,th} so that an overtaking maneuver can be safely completed.

FIGS. 10 and 11 show the situations in the other two cases. In both cases

TTC_{pred}<TTC_{pred,th}

applies to indicator quantity TTC_{pred}, i.e., overtaking is critical or impossible on account of the expected distance from the oncoming vehicle, and falling behind the vehicle driving ahead B is required.

When the situation analysis module 40 detects such a case, the vehicle is slowed down, at a constant deceleration rate, to a value below the velocity of the vehicle driving ahead. However, velocity will not fall below a minimum so that dynamic steering-back will be possible.

For this purpose, the evaluation unit 43 of the situation analysis module 40 triggers a modulator 52 of a braking system of vehicle A in order to initiate a braking process, thereby getting the driver to cut back behind the vehicle driving ahead B. Graduated warnings are provided for an increasing criticality of the overtaking maneuver, e.g., stage 1, stage 2 etc. up to an abortion caused by a braking intervention initiated by the warning-and-intervention module 50.

FIG. 10 shows the situation of an early abortion in which vehicle A can directly cut in behind the vehicle driving ahead B as soon as the velocity V_{A} of vehicle A has adapted to the velocity of the vehicle driving ahead B as a result of a braking process initiated by the evaluation unit 43 at instant t_{brake}, wherein at the same instant tₛₜₑₑᵣ the process of steering vehicle A back into the lane behind the vehicle driving ahead B begins.

Vehicle A according to FIG. 11 is already in the state of passing the vehicle driving ahead B so that vehicle A first has to be slowed down to a point where it has fallen behind the vehicle driving ahead B in order to enable it to cut back at instant tₛₜₑₑᵣ (see diagram 2a according to FIG. 11).

By contrast, according to diagram 2b of FIG. 11, the vehicle is only slowed down to a velocity vₘᵢₙ so that it takes longer to enable it to be steered back into the lane behind the vehicle driving ahead B at instant tₛₜₑₑᵣ.

Both the period of time τ_{req} required for and the period of time τₐᵥₐᵢₗ available for an accident-prevention abortion maneuver are calculated from the current distances and velocities of vehicles A and B. The required period of time is the period that will (probably) pass before vehicle A has left the left traffic lane and cut back into the right lane behind the vehicle driving ahead B. However, in the event of the overtaking vehicle A having to fall behind the vehicle driving ahead B before being able to be steered back, the required period of time will be extended accordingly. In order to be able to determine said period of time even in a situation in which the vehicle driving ahead B has already left the coverage of the forward-oriented surroundings sensor system 10, vehicle A is moved on in a model-based manner according to the method for detecting a driving maneuver. The available period of time τₐᵥₐᵢₗ is the period that will probably pass before the oncoming vehicle C reaches the rear of the vehicle driving ahead B (see FIG. 12 that illustrates an aborted overtaking situation).

According to this, the period of time τ_{req} required for aborting an overtaking maneuver is:

τ_{req}=τ_{NoSteer}+τ_{Steer},

wherein τ_{NoSteer} is the falling-behind period of vehicle A, i.e., the time it takes vehicle A, on the overtaking lane, to fall behind the vehicle driving ahead B in order to be able to cut back afterwards, and τ_{Steer} indicates the duration of the process of steering vehicle A back into the lane of the vehicle driving ahead B, wherein a constant value of, e.g., 3 s is assumed for the last value τ_{Steer}.

The period of time available for aborting the overtaking maneuver results from the quantities of the distance d_{SC} of the front of the oncoming vehicle C from the rear of the vehicle driving ahead B and from the velocities v_{S} and v_{C} of vehicles B and C, respectively, and is calculated as a time-to-collision value TTC_{SC} as follows:

$${TTC}_{BC} = \frac{{d}_{BC}}{{v}_{B} + {v}_{C}} .$$

The difference between the expected duration of the abortion of an overtaking maneuver τ_{req} and the time τₐᵥₐᵢₗ available therefor is used as a basis for the execution of the process of driver assistance. By means of threshold values τ_{diff,th,i} (i=1, 2, . . . ), said difference Δτ_{dif}=τₐᵥₐᵢₗ−τ_{req} triggers off graduated warnings up to the accident-preventing braking intervention (see FIG. 13).

According to said FIG. 13, the t-τ-diagram a) shows the interrelationship between the course of the time difference between the period of time τ_{reg} required for aborting an overtaking maneuver and the time τₐᵥₐᵢₗ available therefor. The diagram also shows the time coordination of information outputted to the driver, warnings and braking interventions.

The t-OTD-diagram b) indicates the detection of an overtaking maneuver, wherein the OTD value is generated from an AND function of indicator quantity I and from indicator TLC according to FIG. 5.

The last diagram c) indicates instant t₁ from which on an overtaking maneuver could become dangerous in the event of the temporal safe distance at the end of the overtaking maneuver (indicated by indicator TTC_{prod}) falling short of an associated threshold value TTC_{prod,th}, said danger being indicated by the result of the evaluation of said indicator TTC_{prod}.

At instant t₂, the evaluation device 43 of the situation analysis module 40 of the driver assistance system 1 according to FIG. 1 detects the beginning of an overtaking maneuver and at the same time calculates the required period of time τ_{req} and the available period of time τₐᵥₐᵢₗ as well as the time difference Δτ_{dif}(t) in dependence on time t. At this instant t₂, no period of time (τ_{NoSteer}=0) would be necessary for cutting back into the lane behind the vehicle driving ahead B since a braking process initiated at this instant would prevent vehicle A from reaching the state “passing”.

Prior to instant t₂, the warning device 51 of the assistance system 1 according to FIG. 1 only informs the driver (e.g., visually) about the fact that a particular overtaking maneuver is dangerous. From instant t₂ on, however, acoustic and/or haptic warnings of increasing intensity can be additionally outputted until the latest possible instant of abortion t₄ when an automatic braking process is initiated.

At instant t₂, a braking process would not prevent vehicle A from reaching the state “passing” so that said vehicle A first has to fall (by being slowed down) behind the vehicle driving ahead B (i.e., τ_{NoSteer}>0). Said required braking process also results in an extension of the period of time τ_{req}.

The driver assistance system 1 according to FIG. 1 that is designed to detect driving maneuvers, in particular overtaking maneuvers and the partial maneuvers thereof such as cutting out, passing and cutting in, can also be used, in an advantageous manner, for swerving to avoid hitting stationary objects, e.g., vehicles standing on the verge, wherein the driver is also warned of oncoming vehicles or the vehicle is slowed down automatically before it reaches the stationary object.

The inventive assistance system can also be used in an advantageous manner in low-velocity travel situations since hitting stationary objects (e.g., obstacles such as bollards or flower tubs and the like) located in, e.g., reduced-traffic areas has to be avoided in such situations as well, wherein the driver is warned or the vehicle is slowed down automatically in the event of oncoming traffic (i.e., other vehicles, cyclists and pedestrians), whereby it is particularly possible to realize an effective protection of pedestrians.

### REFERENCE NUMERALS

1 driver assistance system
10 surroundings sensor system
11 radar sensor system
12 video sensor system
20 vehicle sensor system
30 sensor evaluation unit
31 image processing unit
32 sensor merger unit
40 situation analysis module
41 driving-maneuver detection device
42 object-tracking device
43 evaluation device
50 warning-and-intervention module
51 warning system
52 modulator for a braking system
A vehicle with driver assistance system 1
B vehicle driving ahead
C oncoming vehicle
EKF odometry
G AND gate
K characteristic diagram for determining indicator quantity I
L traffic line, lane line

1. Method for automatically detecting a driving maneuver of a motor vehicle (A), in particular an overtaking maneuver or an evasive maneuver, in which
the surroundings of the vehicle are covered and an electronic image thereof is created,
the electronic image is used for the detection of a traffic lane and/or of a road as well as of objects (B, C) in the surroundings of the vehicle,
longitudinal-dynamics and lateral-dynamics movement information (\dot{ψ}, α_{y}, δ_{H}, ω_{FL}, ω_{FR}, ω_{RL}, ω_{RR}) of motor vehicle (A) is determined, and
the position (\hat{X}) of motor vehicle (A) is odometrically estimated on the basis of the data (b_{Lane}, y_{Lane}, θ, c₀) of lane detection and/or road detection and/or of the movement information (\dot{ψ}, α_{y}, δ_{H}, ω_{FL}, ω_{FR}, ω_{RL}, ω_{RR}) of motor vehicle (A), characterized in that
a) the following indicator quantities are formed from the estimated position data (\hat{X}) of motor vehicle (A):
a value of the lateral distance (LO_{L}, LO_{R}) of motor vehicle (A) from a road marking or traffic line (L),
a time-to-collision value (TTC_{A,B} ) relative to the distance (d) from the object (B) located in the direction of motion, in particular from the vehicle driving ahead (B),
a longitudinal-dynamics overtaking-or-evasive-maneuver indicator (I) formed from the indicator quantity (TTC_{A,B}) of the time-to-collision value and from a value that corresponds to the position (FPS) of the gas pedal of motor vehicle (A), and
b) that threshold values (Iₜₕ, TTC_{A,B}) are determined for said indicator quantities (LO_{L}, LO_{R}, TTC_{A,B}, I), which threshold values are used as criteria for detecting partial maneuvers of an overtaking or evasive maneuver, in particular a maneuver to follow a vehicle driving ahead, a lane change, a maneuver to pass the stationary or moving object (B) and a maneuver to cut into the lane of the overtaken object (B), as well as for detecting transitions between said partial maneuvers.

2. Method according to claim 1, characterized in that a temporal measure of distance (τ) from a stationary or moving object (B) located in the direction of motion, in particular from a vehicle driving ahead (B), and an associated threshold value (τₜₕ) are determined for determining the state “following the vehicle driving ahead (B)” or for determining the state “independent travel of motor vehicle (A)”, said temporal measure of distance (τ) being determined as a further indicator quantity.

3-14. (canceled)

15. Method according to claim 2, characterized in that the state “following a moving object (B)”, in particular “following a vehicle driving ahead (B)”, is detected when the indicator quantity (τ) of the temporal measure of distance falls short of the associated threshold value (τₜₕ).

16. Method according to claim 1, characterized in that a further indicator quantity (TLC) is determined as a time-to-line-crossing value from the data (b_{Lane}, y_{Lane}, θ, c₀) of lane detection and/or road detection and from the movement information (\dot{ψ}, α_{y}, δ_{H}, ω_{FL}, ω_{FR}, ω_{RL}, ω_{RR}) of motor vehicle (A), and an associated threshold value (TLCₜₕ) is determined as a criterion, wherein said threshold value (TLCₜₕ) is used together with the criterion for the longitudinal-dynamics overtaking indicator (I) and the threshold value (Iₜₕ) thereof for the prediction of the beginning of an overtaking maneuver or an evasive maneuver.

17. Method according to claim 16, characterized in that the threshold value (TLCₜₕ) is formed as a criterion of the indicator quantity (TLC) of the time-to-line-crossing value in dependence on the longitudinal-dynamics overtaking indicator (I).

18. Method according to claim 1, characterized in that a lane change or a maneuver to cut out into an adjacent lane is detected and interpreted as the beginning of an overtaking maneuver when the value of the indicator quantity (LO, LO_{R}, LO_{L}) of the lateral distance of vehicle (A) from a lane line (L) that demarcates an oncoming lane is negative.

19. Method according to claim 18, characterized in that an abortion of the lane change or of the cutting-out maneuver is detected when the indicator quantity (TTC_{A,B}) of the time-to-collision value cannot be determined on the basis of the data of the movement information (\dot{ψ}, α_{y}, δ_{H}, ω_{FL}, ω_{FR}, ω_{RL}, ω_{RR}) of motor vehicle (A) and of the value of the distance (d) of motor vehicle (A) from the stationary or moving object (B) located in the direction of motion and/or when the indicator quantity (LO, LO_{R}, LO_{L}) of the lateral distance of vehicle (A) from a lane line (L) that demarcates an oncoming lane becomes positive.

20. Method according to claim 18, characterized in that the state “passing”, in particular a continuation of an initiated overtaking maneuver, is detected when the value of the distance (LO, LO_{R}, LO_{L}) of motor vehicle (A) from the stationary or moving object (B) located in the direction of motion is negative.

21. Method according to claim 20, characterized in that in the event of the indicator quantity (TTC_{A,B}) of the time-to-collision value being determinable during the state “passing a vehicle driving ahead (B)”, an abortion of the passing maneuver is detected when said indicator quantity (TTC_{A,B}) falls short of an associated threshold value (TTC_{A,B,th}).

22. Method according to claim 1, characterized in that a cutting-in maneuver as a partial maneuver completing an overtaking maneuver is detected when the value of the indicator quantity (LO, LO_{R}, LO_{L}) of the value of the lateral distance of vehicle (A) from a lane line (L) that demarcates an oncoming lane becomes positive and when the indicator quantity (LO, LO_{R}, LO_{L}) of the value of the distance of motor vehicle (A) from the overtaken object (B), in particular from the vehicle driving ahead (B), is smaller than the negative sum of the length (l_{ego}, l_{obj}) of motor vehicle (A) and of the overtaken object (B).

23. Method according to claim 22, characterized in that the value of the distance from the front right corner of motor vehicle (A) is used as an indicator quantity (LO, LO_{R}) of the value of the lateral distance of vehicle (A) from a lane line (L) demarcating an oncoming lane for detecting a cutting-in maneuver.

24. Method according to claim 1, characterized in that the value of the distance from the front left corner of the motor vehicle is used as an indicator quantity (LO, LO_{L}) of the value of the lateral distance of vehicle (A) from a lane line (L) demarcating an oncoming lane for detecting a lane change or a maneuver to cut out into an adjacent lane.

25. Driver assistance system (1) for a motor vehicle (A), for carrying out the method according to claim 1, comprising an overtaking-maneuver assistance system or an evasive-maneuver assistance system, which comprises
a surroundings sensor system (10) for lane and road detection and for locating objects (B, C) in the surroundings of motor vehicle (A),
a sensor evaluation unit (30) for creating an electronic image of the surroundings of motor vehicle (A),
a vehicle sensor system (20) for acquiring dynamic movement information,
a driving-maneuver detection device (40, 41) for carrying out the method according to claim 1 for detecting partial maneuvers of an overtaking or evasive maneuver, in particular a maneuver to follow (\dot{ψ}, α_{y}, δ_{H}, ω_{FL}, ω_{FR}, ω_{RL}, ω_{RR}) a vehicle driving ahead (B), a lane change, a maneuver to pass a moving or stationary object (B) and a maneuver to cut into the lane of an overtaken object (B), as well as for detecting transitions between said partial maneuvers,
an object-tracking device (40, 42) for tracking detected oncoming vehicles (C) or objects (C) on the basis of the surroundings sensor system (10),
an evaluation device (40, 43) for assessing and determining the feasibility of the detected driving maneuvers and/or partial maneuvers with respect to the detected oncoming vehicles (C) and/or objects (C), for controlling a warning device (50, 51) for outputting warnings to the driver when an overtaking maneuver has been predicted or during a detected overtaking maneuver when the detected driving maneuver and/or partial maneuver is assessed to be critical or non-feasible, and/or for actuating one or several modulators (50, 52) of vehicle-relevant functions, in particular the brake and/or the steering gear and/or the drivetrain, when the danger of a collision with a detected oncoming vehicle (C) and/or object (C) has been detected.

26. Driver assistance system according to claim 25, characterized in that the evaluation device (43) is designed for determining an indicator quantity (TTC_{prod}) for assessing a predicted or detected overtaking maneuver, wherein said indicator quantity (TTC_{pred}) is determined on the basis of the data of the vehicle sensor system (20) and of the object-tracking device (42) for the predicted time of the end of the predicted or detected overtaking maneuver as a time-to-collision value for the detected oncoming vehicle (C) and/or object (C) and an associated threshold value (TTC_{pred,th}) is determined.
